(19) United States
(12) Patent Application Publication
(10) Pub. No.: US 2026/0215356 A1
(43) Pub. Date: Jul. 30, 2026

(54) Proper Implement Based on Remote Sensor Data of Implement Operation

(71) Applicant: Autonomous Solutions, Inc., Mendon, UT (US)

(72) Inventors: Robert Ashby, Mendon, UT (US); Bret Turpin, Mendon, UT (US); Mitch Torrie, Mendon, UT (US)

(73) Assignee: Autonomous Solutions, Inc., Mendon, UT (US)

(21) Appl. No.: 19/461,642

(22) Filed: Jan. 27, 2026

Related U.S. Application Data
(60) Provisional application No. 63/751,409, filed on Jan. 30, 2025.

(51) Int. Cl. A01B 69/04; A01B 69/00; G05D 1/65; G05D 1/86; G05D 105/15; G05D 107/20; G05D 109/10; G05D 111/10

(52) U.S. Cl. CPC A01B 69/008; A01B 69/004; G05D 1/65; G05D 1/86; G05D 2105/15; G05D 2107/21; G05D 2109/10; G05D 2111/17

(57) ABSTRACT

Disclosed are autonomous work vehicles, adjustable implement systems, and autonomous vehicle systems for executing an operational adjustment of the vehicle and/or implement during an operational task upon detecting a temperature of the implement that lies outside an operational envelope. The operational adjustment may comprise adjusting an operational parameter of the vehicle (e.g., velocity, heading, engine torque, etc.) and/or the implement (e.g., implement position) to a desired value. The desired value may be configured to return the implement to a temperature within the operational envelope, to reduce or prevent harm to the implement, and/or to increase the effectiveness of the operational task. Detecting a temperature of implement outside the operational envelope may induce the autonomous work vehicle to provide an abnormal temperature notification to an operator.

### BACKGROUND

Vehicles systems including tractors and implements often require some positional feedback of the implement. Typically, the position of an implement is monitored by sensors on an implement.

### SUMMARY

Disclosed are autonomous work vehicles, adjustable implement systems, autonomous vehicle systems configured to perform operational adjustments (e.g., during an operational task) upon detecting a temperature of an implement or a component of the implement. The operational adjustment may be performed when the detected temperature is found to be outside an operational envelope. The operational adjustment may be configured to return the temperature of the implement or component to a temperature lying within the operational envelope. Doing so may beneficially improve the effectiveness of the performance of the operational task, reduce or prevent excessive wear and/or damage to the implement and/or the autonomous work vehicle, and/or reduce material and fuel waste.

The autonomous work vehicle may comprise a steering control system for autonomously controlling a driving direction of the autonomous work vehicle and a speed control system for autonomously controlling a speed of the autonomous work vehicle. The autonomous work vehicle may also comprise an implement connection between the autonomous work vehicle and an implement, and the implement may be configured to interface with objects of an operating environment. The autonomous work vehicle may comprise an implement control system for autonomously controlling a position of the implement and a sensor array comprising one or more sensors configured to measure temperature of one or more implement components of the implement.

The autonomous work vehicle may comprise one or more processors communicatively coupled with the sensor array, the steering control system, the speed control system, and the implement control system for driving the autonomous work vehicle and adjusting the performance and/or settings (e.g., position) of the implement. The autonomous work vehicle may comprise one or more computer-readable media having stored thereon instructions that when executed cause the one or more processors to implement a method for adjusting the performance of the operational task by adjusting the operational parameters of the autonomous work vehicle and/or the implement.

The method may comprise receiving implement data from the sensor array, wherein the implement data indicates a temperature of one or more implement components. The method may then include determining a first temperature of a first component of the one or more implement components and comparing the first temperature to an associated operational envelope of the implement. When the first temperature of the first component is outside the operational envelope the method may comprise calculating a desired value of an operational parameter of the autonomous work vehicle or implement and perform an operational adjustment by instructing the implement control system, the steering control system, and/or the speed control system to adjust the operational parameter of the autonomous work vehicle or implement to the desired value. The desired value of the operational parameter may be configured to return the first component to a second temperature lying within the operational envelope.

For example, the operational parameter may comprise a position of the first component of the one or more components of the implement, the desired value may comprise a desired position of the first component, and performing the operational adjustment may comprise instructing the implement control system to adjust a position of the first component to the desired position.

In another example, the operational parameter may comprise a velocity of the autonomous work vehicle, the desired value may comprise a desired velocity of the autonomous work vehicle, and performing the operational adjustment may comprise instructing the speed control system to adjust a velocity of the autonomous work vehicle to the desired velocity. In another example, the operational parameter may comprise a selected path of the autonomous work vehicle, the desired value may comprise a deviation from the selected path, and performing the operational adjustment may comprise instructing the steering control system to follow the deviation from the selected path. The method may additionally, or alternatively, comprise, when the first temperature of the first component is outside the operational envelope, sending an abnormal temperature notification to an operator.

The method may further comprise determining a third temperature of a second component of the one or more implement components and comparing the third temperature to the operational envelope. When the first temperature and the third temperature lie outside the operational envelope the method may include calculating the desired value of the operational parameter of the autonomous work vehicle or implement. The desired value of the operational parameter of the autonomous work vehicle or implement can be configured to return the first component to a second temperature lying within the operational envelope and to return the second component to a fourth temperature lying within the operational envelope. The method may then include instructing the implement control system, the steering control system, and/or the speed control system to adjust the operational parameter of the autonomous work vehicle or implement to the desired value. Comparing the first temperature and the third temperature to the operational envelope may comprise determining a temperature difference between the first temperature and the third temperature, and the first temperature and third temperature may lie outside the operational envelope when the temperature difference between the first temperature and the third temperature exceeds a difference threshold of the operational envelope.

The one or more sensors of the sensor array comprise an infrared sensor, a thermal imager, a pyrometer, or a LiDAR sensor. A first sensor of the sensor array may generate operational data, wherein the operational data includes the implement data used to determine the first temperature of the first component and environmental data that represents the operating environment of the autonomous work vehicle. The method may then include generating a path through an operating environment based on the environmental data and instructing the steering control system and the speed control system to drive the autonomous work vehicle along the path. The method may comprise receiving environmental data from the sensor array, wherein the environmental data indicates a temperature profile of a substrate of the operating environment lying behind the implement.

The operational parameter can comprise engine torque, fuel burn rate, traction, wheel slip, engine rpm, steering effectiveness, and/or a velocity of the autonomous work vehicle. The implement can comprise a tillage implement or seeder comprising a ground engaging tool configured to penetrate a substrate. The operating parameter may comprise an operating depth of the ground engaging tool and the method may comprise determining, based on the operational parameter, whether the ground engaging tool is operating at a correct depth in the substrate based on comparison of the first temperature to the associated operational envelope. Also disclosed are non-transitory computer-readable storage mediums comprising instructions for executing the above method.

An autonomous work vehicle comprising a steering control system for autonomously controlling a driving direction of the autonomous work vehicle, a speed control system for autonomously controlling a speed of the autonomous work vehicle, an implement connection between the autonomous work vehicle and an implement, wherein the implement is configured to interface with objects of an operating environment, an implement control system for autonomously controlling a position of the implement, a sensor array comprising one or more sensors configured to measure temperature of one or more implement components of the implement, one or more processors communicatively coupled with the sensor array, the steering control system, the speed control system, and the implement control system, and one or more computer-readable media having stored thereon instructions that when executed cause the one or more processors to receive implement data from the sensor array, wherein the implement data indicates a temperature of one or more implement components, determine a first temperature of a first component of the one or more implement components, compare the first temperature to an associated operational envelope of the first implement, and when the first temperature of the first component is outside the operational envelope, send an abnormal temperature notification to an operator.

These illustrative embodiments are mentioned not to limit or define the disclosure, but to provide examples to aid understanding. Additional embodiments are discussed in the Detailed Description, and further description is provided there. Advantages offered by one or more of the various embodiments may be further understood by examining this specification or by practicing one or more embodiments presented.

### BRIEF DESCRIPTION OF THE FIGURES

These and other features, aspects, and advantages of the present disclosure are better understood when the following Detailed Description is read with reference to the accompanying Drawings. In the Drawings, like reference numerals may be utilized to designate corresponding or similar parts in the various Figures, and the various elements depicted are not necessarily drawn to scale, wherein:

FIG. 1 schematically shows an isometric view of an example vehicle system including a tractor with an implement.

FIG. 2 illustrates a block diagram of an example autonomous work vehicle communication system of the present disclosure.

FIG. 3 is a side view of an autonomous yard truck according to some embodiments.

FIG. 4 is a perspective view of an autonomous mower according to some embodiments.

FIG. 5 is a side view of an autonomous tractor according to some embodiments.

FIG. 6 shows an illustrative computational system for performing functionality to facilitate implementation of embodiments described in this document.

FIG. 7 is a flow chart of an example process for correcting operation of an implement.

FIG. 8 is a flow chart of a more specific example process for correcting operation of an implement.

FIG. 9 is a front view of an example portion of an implement.

### DETAILED DESCRIPTION

Implements may be attached to work vehicles to perform particular tasks. For example, farming implements may be attached to tractors to perform agricultural tasks, such as preparing soil, planting, fertilizing, applying pesticide, and harvesting tasks. Construction vehicles may rely on attached implements for preparing worksites, moving materials, and otherwise facilitating the building of structures.

The development of autonomous work vehicles may beneficially reduce the manual labor of human operators required to drive work vehicles and perform associated tasks. The need for autonomously-directed implements has grown with the development of autonomously-driving work vehicles. Developments include autonomous control of autonomous work vehicles and implements to perform tasks.

However, despite this the effectiveness of implements may vary during the operational task performed by the autonomous vehicle system. Implements may frequently malfunction or may be used incorrectly, even by autonomous systems designed to control such implements. This may lead to decreased effectiveness of the operational task and/or to harm of the implement as the implement continues to be used in a malfunctioning state. What are needed are systems and methods for detecting implement malfunction or misuse during the performance of the operational task.

Disclosed are autonomous work vehicles, adjustable implement systems, and methods for detecting implements operating outside an operational envelope, including operating at temperatures outside of the operational envelope. Detection of implement temperatures may be accomplished through analysis of implement data sent from one or more sensors of a sensor array. Detection of temperature (and/or other factors) may enable the system to infer the position of the implement.

Upon detection of temperatures lying outside the operational envelope, the autonomous vehicle system may adjust one or more operational parameters of the autonomous work vehicle and/or the implement to a desired value. This operational adjustment may return the implement to a temperature within the operational envelope, which may improve effectiveness and/or efficiency of the task or reduce harm to the implement. Adjustment of the one or more parameters may include adjusting a position of the implement, adjusting a velocity of the vehicle, and/or deviating from a path of the vehicle. The implement may be connected to a hydraulic cylinder and the operational adjustment may comprise adjusting a flow rate of the fluid within the hydraulic cylinder.

While the disclosed methods may be employed to control an implement of an autonomous work vehicle, the disclosed methods may be used in other contexts. For example, an operator may drive a vehicle and operate an implement simultaneously. Frequently, driving conditions may cause the position of the implement to deviate or malfunction and the operator may not be aware of the malfunction for a period of time due to the attention needed to drive the vehicle. This may lead to reduced efficacy and/or efficiency of the performance of the task. However, the disclosed systems and methods may be employed to adjust the position of the implement attached to a manually-driven vehicle. The disclosed controlled implement systems may beneficially optimize performance, reduce and/or prevent operational delays or harm to the implement, and improve energy and material efficiency. This may also beneficially prevent or reduce wear on equipment of the vehicle and/or implement, for example, due to changing conditions within the operating environment and/or poor decision making of an operator.

As used herein, the term “autonomous work vehicle” may refer to a vehicle configured to perform a task within an operating environment. The autonomous work vehicle may refer to a vehicle that may be driven by an autonomous system with little or no human input. The autonomous work vehicle may refer to a driving unit (e.g., a tractor) attached to an implement, or may refer to the driving unit as distinct from the implement. While an autonomous work vehicle is described in connection to the disclosed embodiments throughout this description, manually-operated vehicles may alternatively be used. Considering this, wherever possible, one may substitute the term “autonomous work vehicle” with the term “work vehicle,” “manual vehicle,” “manned vehicle,” “manually-operated vehicle,” or other term indicating a non-autonomously-driven vehicle.

As used herein, the term “implement” may refer to a device connected (detachably or permanently) to a vehicle and which is configured to interface and/or interact with objects (beyond the vehicle to which it is connected) within the operating environment. The implement may include farming implements, construction implements, or other vehicle attachments. The implement may include a vehicle connection point for detachably and/or pivotably connecting the implement to a vehicle (e.g., an autonomous work vehicle). The implement may be configured, for example, to move objects within the operating environment, to cut or partition objects, or to bind objects together. The implement may configured to interface with a ground surface of the operating environment.

As used herein, the term “autonomous vehicle system,” “autonomous work vehicle system,” or related terms may refer to the combination of the autonomous work vehicle hardware (including sensors), an attached implement (including sensors), and the software that enables the vehicle to perform an operational task autonomously. The term may refer to the autonomous work vehicle and an attached implement, and/or may include the software and hardware for executing the methods described below and/or the computer-readable media storing such methods. In some embodiments, the term may additionally include the base station that communicates with the autonomous work vehicle.

As used herein, the term “automatic” may refer to an action, process, or system that is performed or performs with reduced human intervention. Automatic systems may continue to receive a minimum of human input to complete performance. An automatic system may enable performance by the system with less human input when compared to a non-automatic or manual system.

As used herein, the term “autonomous” may refer to an action, process, or system that may perform or be performed without any human input or intervention. An “automatic system” may be “autonomous” when it relies on no human input to perform a process of the system.

As used herein, the term “operator” may refer to a manual driver of the work vehicle, who may be present within the cab of the vehicle or may refer to a remote operator that drives the work vehicle from a distance. The operator may refer to a remote operator that may receive sensor data from the work vehicle to drive, manage, and/or troubleshoot the work vehicle from a distance. For example, if the autonomous work vehicle pauses or stops (e.g., due to encountering an unknown situation or an operational or sensor failure), a remote operator may receive sensor data (e.g., an image of an unexpected obstacle) of the operating environment, and the remote operator may then upon examination of the sensor data configure the autonomous work vehicle to resume operation. In some embodiments, the operator may refer to a technician that services the work vehicle for maintenance and repair, and/or who may troubleshoot the work vehicle, especially during operational pauses of the work vehicle (e.g., autonomous work vehicle).

As used herein, the term “operational parameter” may refer to a setting that may be directly adjusted (e.g., by a control system of the autonomous work vehicle and/or implement) during performance of an operational task of the autonomous work vehicle system. The setting may be individually adjusted or may be adjusted in combination with one or more settings. For example, the operational parameter(s) may include a velocity, a wheel speed, engine torque, fuel burn rate, traction, wheel slip, engineer rpm, steering effectiveness, and/or a heading or path of the autonomous work vehicle, or may include a height, penetration depth, extension, speed, position, hydraulic fluid volume, hydraulic fluid flow rate, and/or power input of an attached implement.

As used herein, the term “operational variable” may refer to phenomena of the autonomous work vehicle and/or implement that may be measured by one or more sensors (e.g., of a sensor array) of the autonomous work vehicle. The phenomena may be directly measurable or may be inferred from data sent by the one or more sensors. The phenomena may correspond or directly indicate an operational parameter. For example, an operation parameter of wheel speed of the autonomous work vehicle may be detected within data sent from a sensor that may have a field of view including the wheel of the vehicle and which may indicate the rotation of the wheel. The phenomena measured by the one or more sensors may not be directly adjusted with an operational parameter. For example (and as illustrated below), a temperature of one or more components of an implement may be measured or indicated by data sent from the one more sensors. While the temperature of the one or more components may not be changed directly by adjusting an operational parameter, adjusting one or more operational parameters may indirectly induce or influence change of the operational variable.

As used herein, the term “operational envelope” may refer to the safe, efficient boundaries for the autonomous vehicle system. The term may refer to the values of operational variables at which operation of the implement and/or autonomous work vehicle are safe, calculated to perform the operational task, for example, without harm to the implement or vehicle, or without harm to the operating environment and/or objects within the operating environment.

Systems and/or methods are disclosed for determining a position of an implement attached to an autonomous vehicle (e.g., tractor 112), and for controlling the position of the implement.

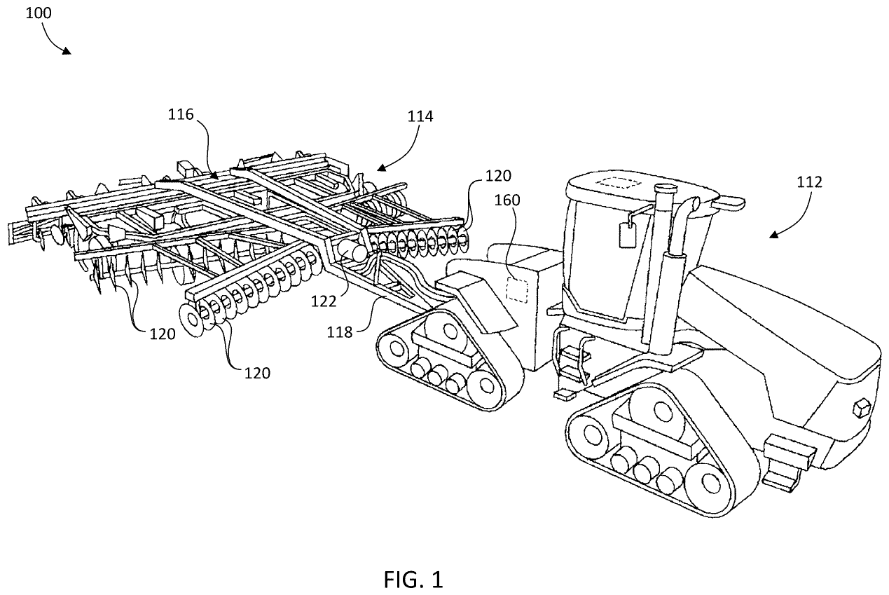

FIG. 1 is a diagram illustrating an autonomous vehicle system 100 including a tractor 112 comprising an implement 114 attached thereto. The autonomous vehicle system 100 may include a vehicle, including an autonomous work vehicle. The autonomous work vehicle may refer to the tractor 112 wherever the autonomous work vehicle is described in this document. The implement 114 in this example is a disc harrow which is carried behind the tractor 112. In other examples, the implement may be any tillage implement including, for example, a ground engaging tool configured to penetrate a substrate, or may be a digger bucket, a dump truck bed, a plough, a harvesting implement, a cultivator, a plow, a chisel, a mower, a grader, a harvester, a rake, a rock picker, a tiller, a rotavator, a ditcher, a dozer blade, a backhoe, a seeder, a tiller, a fertilizer, a spreader, an excavator, a disc plow, a disc harrows, a blade, etc. The implement 114 may, for example, comprise a frame 116 including a tow bar 118 by which the implement 114 can be towed by the tractor 112. A plurality of discs 120 may be arranged in rows on either side of the tow bar 118. The discs 120 may be mounted to the frame 116 with bearings (not shown) and may be configured to rotate, via the bearings, on an axis parallel to a respective row in which the disc 120 is arranged.

The autonomous vehicle system 100 may comprise a hydraulic cylinder 122 to which the implement 114 is attached and which is configured to enable movement of the implement 114 between different positions by extending and retracting. Movement of the implement 114 to a different position may relate to different positions relative to the tractor 112, or movement to a different absolute position in space. The hydraulic cylinder 122 may be a separate component to the implement 114, or in some examples, the hydraulic cylinder 122 may be considered to be a part of the implement, such that it is configured to enable movement of another part of the implement by extending or retracting. The hydraulic cylinder 122 may have its own engine or hydraulic pump, or an engine or hydraulic pump may be run be a power take-off from the tractor 112. A sensor array 160 may be disposed on the tractor 112 and may be configured to monitor the implement 114 remotely from the tractor 112, for example, with a camera, LiDAR, radar, or an infrared camera.

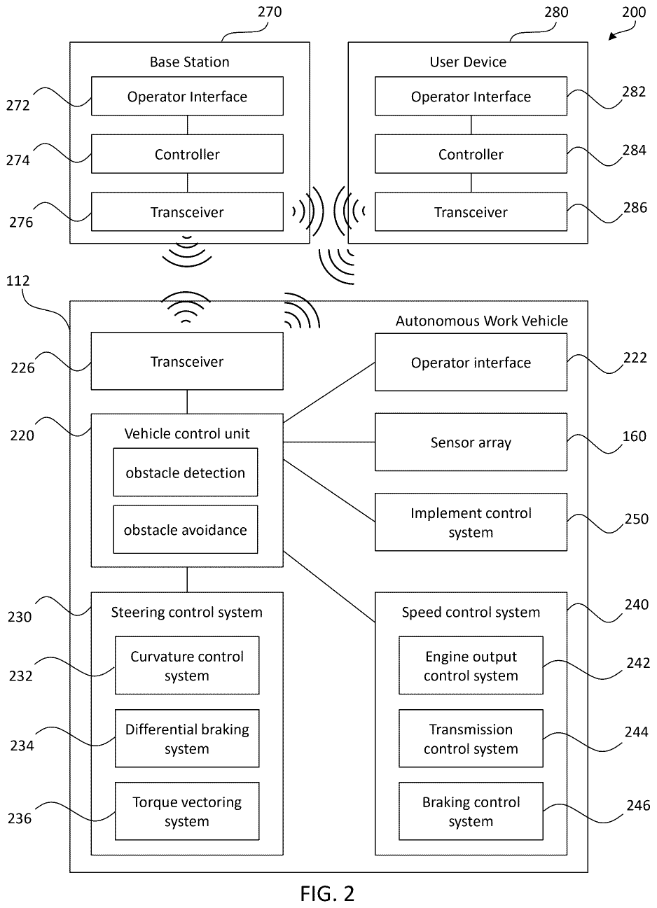

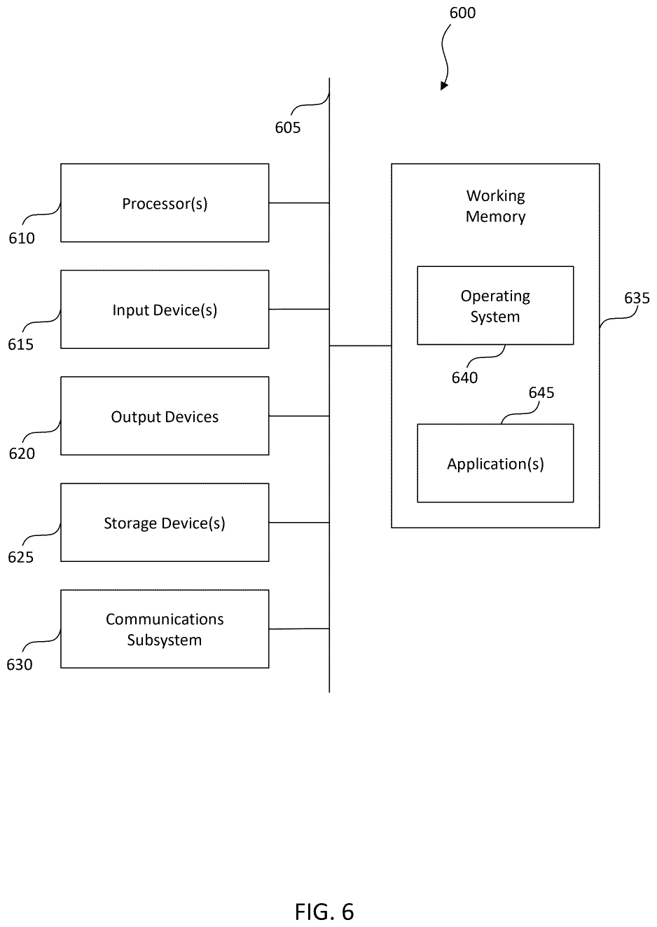

FIG. 2 is a block diagram of a communication and control system 200 that may be utilized in conjunction with the systems and methods of the disclosure. All or some of the components of control system 200 may or may not be included in an autonomous vehicle in any combination. All or some of the components of control system 200 may be included in an autonomous vehicle, an implement, a remote system in any combination. The communication and control system 200 may include a vehicle control unit 220 which may be mounted on the autonomous work vehicle. The autonomous work vehicle, for example, may include any agricultural or construction machinery including, for example, a yard truck, loader, wheel loader, track loader, dump truck, digger, backhoe, forklift, harvester, tractor, land leveler, scraper, dozer, trencher, grader, seeder, fertilizer, spreader, mower (e.g., lawn, field, or brush mower), harrow, etc., any machinery or implement discussed in this document, or other vehicle or implement. The communication and control system 200, for example, may include any or all components of computational system 600 shown in FIG. 6, described below.

For example, the autonomous work vehicle may include a steering control system 230 that may control a direction of movement of the autonomous work vehicle. The steering control system 230, for example, may include any or all components of computational system 600 shown in FIG. 6.

The autonomous work vehicle, for example, may include a speed control system 240 that controls the speed, acceleration, and deceleration of the autonomous work vehicle. The speed control system 240, for example, may control the speed of the autonomous work vehicle based on map data, control algorithms, obstacle detection, start and/or stop points, input from the base station 270 and/or operator (e.g., a remote operator), etc. The speed control system 240, for example, may include any or all components of computational system 600 shown in FIG. 6.

The autonomous work vehicle, for example, may include an implement control system 250 that may control operation of an implement towed by the autonomous work vehicle (e.g., tractor 112), integrated within the autonomous work vehicle, or coupled to the autonomous work vehicle. The implement control system 250, for example, may include any type of implement such as, for example, a tillage implement such as a ground engaging tool configured to penetrate a substrate, a disc harrow, a bucket (e.g., a digger bucket), a shovel, a blade, a thumb, a dump bed (e.g., a dump truck bed), a plow, a harvesting implement, an auger, a trencher, a scraper, a broom, a hammer, a grapple, forks, boom, spears, a cutter, a wrist, a tiller, a rake, a cultivator, a chisel, a mower, a grader, a harvester, a rake, a rock picker, a rotavator, a ditcher, a dozer blade, a backhoe, an excavator, a disc plow, disc harrows, a seeder, a fertilizer, etc. The implement control system 250, for example, may include any or all components of computational system 600 shown in FIG. 6.

An implement may also be considered an attachment. An implement may be coupled with the autonomous vehicle by a user or may be integrated with the autonomous vehicle.

The vehicle control unit 220 may be communicatively coupled with the steering control system 230, the speed control system 240, and/or the implement control system 250. The vehicle control unit 220, for example, may include any or all of the components shown in FIG. 6. The vehicle control unit 220, for example, may be integrated into a single controller or may include a plurality of distinct components or controllers. The vehicle control unit 220 may also be coupled with one or more sensors from the sensor array 160 and receive sensor data from the sensor array 160.

The vehicle control unit 220, for example, may be used to control various aspects of the vehicle such as, for example, sending instructions to the steering control system 230, implement control system 250, speed control system 240, etc. The vehicle control unit 220, for example, may include a vehicle artificial intelligence (VAI) that may include one or more processors that execute one or more algorithms, including processes 700 and/or 800 disclosed below.

The vehicle control unit 220, for example, may receive signals relative to many parameters of interest including, but not limited to: vehicle position, vehicle speed, vehicle heading, desired path location, off-path normal error, desired off-path normal error, heading error, vehicle state vector information, curvature state vector information, turning radius limits, steering angle, steering angle limits, steering rate limits, curvature, curvature rate, rate of curvature limits, roll, pitch, rotational rates, acceleration, engine loading, engine torque, and the like, or any combination thereof. These signals, for example, may come from the sensor array 160 or from a base station 270 (described below).

The vehicle control unit 220, for example, may be an electronic controller with electrical circuitry configured to process data from the various components of the autonomous work vehicle. The vehicle control unit 220 may include a processor, such as the processor 610, and a working memory 635. The vehicle control unit 220 may also include one or more storage devices, storage media, and/or other suitable components of computational system 600. The processor may be used to execute software, such as software for calculating drivable path plans. Moreover, the processor may include multiple microprocessors, one or more “general-purpose” microprocessors, one or more special-purpose microprocessors, and/or one or more application specific integrated circuits (ASICS), or any combination thereof. For example, the processor may include one or more reduced instruction set (RISC) processors. The vehicle control unit 220, for example, may include any or all the components shown in FIG. 6.

The vehicle control unit 220, for example, may include a volatile memory, such as random access memory (RAM), and/or a nonvolatile memory, such as ROM (e.g., working memory 635, storage device 625, and/or other computer-readable media). The memory may store a variety of information and may be used for various purposes. For example, the memory may store processor-executable instructions (e.g., firmware or software) for the vehicle control unit 220 to execute, such as instructions for calculating a drivable path plan, and/or controlling the autonomous work vehicle (e.g., for implementing processes 700 and/or 800 below). The memory may include flash memory, one or more hard drives, or any other suitable optical, magnetic, or solid-state storage medium, or a combination thereof. The memory may store data such as field maps, maps of desired paths, vehicle characteristics, software or firmware instructions, and/or any other suitable data.

The steering control system 230, for example, may include a curvature rate control system 232, a differential braking system 234, a steering mechanism, and a torque vectoring system 236 that may be used to steer the autonomous work vehicle. The curvature rate control system 232, for example, may control a direction of an autonomous work vehicle by controlling a steering control system of the autonomous work vehicle with a curvature rate, such as an Ackerman style autonomous work vehicle, 210 or articulating vehicle. The curvature rate control system 232, for example, may automatically rotate one or more wheels or tracks of the autonomous work vehicle via hydraulic or electric actuators to steer the autonomous work vehicle. By way of example, the curvature rate control system 232 may rotate front wheels/tracks, rear wheels/tracks, and/or intermediate wheels/tracks of the autonomous work vehicle or articulate the frame of the vehicle, either individually or in groups. The differential braking system 234 may independently vary the braking force on each lateral side of the autonomous work vehicle to direct the autonomous work vehicle. Similarly, the torque vectoring system 236 may differentially apply torque from the engine to the wheels and/or tracks on each lateral side of the autonomous work vehicle. While the illustrated steering control system 230 includes the curvature rate control system 232, the differential braking system 234, and the torque vectoring system 236, the steering control system 230 may include one or more of these systems. Further examples may include a steering control system 230 having other and/or additional systems to facilitate turning the autonomous work vehicle such as an articulated steering control system, a differential drive system, and the like.

The speed control system 240, for example, may include an engine output control system 242, a transmission control system 244, and a braking control system 246. The engine output control system 242 may vary the output of the engine to control the speed of the autonomous work vehicle. For example, the engine output control system 242 may vary a throttle setting of the engine, a fuel/air mixture of the engine, a timing of the engine, and/or other suitable engine parameters to control engine output. In addition, the transmission control system 244 may adjust gear selection within a transmission to control the speed of the autonomous work vehicle. Furthermore, the braking control system 246 may adjust the braking force to control the speed of the autonomous work vehicle. While the illustrated speed control system 240 includes the engine output control system 242, the transmission control system 244, and the braking control system 246, the speed control system 240 may include one or two of these systems. The speed control system 240, for example, may also include other systems and/or additional systems that may be used to control the speed of the autonomous work vehicle.

The implement control system 250, for example, may control various parameters of the implement towed by and/or integrated within the autonomous work vehicle. For example, the implement control system 250 may instruct an implement controller via a communication link, such as a CAN bus, ISOBUS, Ethernet, wireless communications, and/or Broad R Reach type Automotive Ethernet, etc.

The implement control system 250, for example, may instruct an implement controller to adjust a penetration depth of at least one ground engaging tool of an agricultural implement, which may reduce the draft load on the autonomous work vehicle.

The implement control system 250, as another example, may instruct the implement controller to transition an agricultural implement between a working position and a transport portion, for example by means of extending or retracting a hydraulic cylinder 122, to adjust a flow rate of product from the agricultural implement, to adjust a position of a header of the agricultural implement (e.g., a harvester, etc.), among other operations, etc. The implement control system 250, as another example, may instruct the implement controller to adjust a shovel height, a shovel angle, a shovel position, a disc height or position, a dump bucket height or position, etc.

The communication and control system 200, for example, may include a sensor array 160. The sensor array 160, for example, may facilitate determination of condition(s) of the autonomous work vehicle (e.g., tractor 112), the implement 114, and/or the work area. For example, the sensor array 160 may include one or more sensors (e.g., infrared sensors, ultrasonic sensors, magnetic sensors, tachometer, radar sensors, LiDAR sensors, terahertz sensors, sonar sensors, wheel encoders, cameras, etc.) that monitor a rotation rate of a respective wheel (i.e., wheel speed) and/or track a ground speed of the autonomous work vehicle. The sensors may also include an engine torque sensor, a vehicle speed sensor, a wheel speed sensor, a vehicle position sensor, a vehicle direction sensor, a steering sensor configured to monitor the steering of the autonomous work vehicle, a fuel sensor, and/or an engine rpm sensor. The sensors (e.g., of the sensor array 160) may alternatively or additionally monitor operating levels (e.g., temperature, fuel level, fuel burn rate, engine torque, engine rpm, wheel slip and/or traction, steering effectiveness, vehicle direction, hydraulic fluid pump speed, and/or hydraulic fluid flow rate into or out of the hydraulic cylinder 122, etc.) of the autonomous work vehicle. The sensors of the sensor array 160 may be external sensor added to an existing autonomous vehicle or integrated with or part of the autonomous work vehicle. Furthermore, the sensors may include sensors which can remotely monitor the implement 114 from the tractor 112, such as LiDAR sensors, radar sensors, infrared sensors, cameras etc. Yet further, the sensors may monitor conditions in and around the work area, such as temperature, weather, wind speed, compass, humidity, and other conditions. The sensors of the sensor array 160, for example, may detect physical objects in the work area, such as a parking stall, a material stall, accessories, other vehicles, obstacles, environmental features, or other object(s) that may be in the area surrounding the autonomous work vehicle. The sensors of the sensor array 160 may be a part of the original equipment manufacturer system, or may be added onto the tractor 112.

The sensor array 160, for example, may include a velocity sensor which may include one or more of an inertial measurement unit, a compass, a GPS sensor, a wheel encoder, a tachometer, a camera, a radar, a LiDAR sensor, an infrared camera or sensor, etc. The camera, radar, LiDAR sensor, and/or infrared camera or sensor may be pointed at the implement 114 to monitor the implement 114 remotely. The sensor array 160, for example, may also include a steering angle sensor. The velocity sensor, for example, may produce velocity data. Velocity data may include information regarding speed and/or bearing. Velocity data, for example, may additionally, or alternatively, include information regarding the steering angular rate.

The autonomous work vehicle may include an operator interface 222 for controlling the vehicle. The operator interface 222, for example, may be communicatively coupled to the vehicle control unit 220 and configured to present data from the autonomous work vehicle via a display. Display data may include data associated with operation of the autonomous work vehicle, data associated with operation of an implement, data associated with implement health, a position of the autonomous work vehicle, a speed of the autonomous work vehicle, a desired path, a drivable path plan, a target position, a current position, engine toque and/or rpm, fuel burn rate, traction tractor wheel speed, and/or steering effectiveness, etc. The operator interface 222 may enable an operator to control certain functions of the autonomous work vehicle such as starting and stopping the autonomous work vehicle, inputting a desired path, etc. The operator interface 222, for example, may enable the operator to input parameters that cause the vehicle control unit 220 to adjust the drivable path plan. For example, the operator may provide an input requesting that the desired path be acquired as quickly as possible, that an off-path normal error be minimized, that a speed of the autonomous work vehicle remain within certain limits, and/or that a lateral acceleration experienced by the autonomous work vehicle remain within certain limits, etc. In addition, the operator interface 222 (e.g., via the display, or via an audio system (not shown), etc.) may alert an operator if the desired path cannot be achieved, for example.

The communication and control system 200, for example, may include a base station 270 having a base station controller 274 located remotely from the autonomous work vehicle. For example, the control functions of the vehicle control unit 220 may be distributed between the vehicle control unit 220 of the autonomous work vehicle and the base station controller 274. The base station controller 274, for example, may perform a substantial portion of the control functions of the vehicle control unit 220. For example, a first transceiver 226 positioned on the autonomous work vehicle may output signals indicative of vehicle characteristics (e.g., position, speed, heading, curvature rate, curvature rate limits, maximum turning rate, minimum turning radius, steering angle, roll, pitch, rotational rates, acceleration, etc.) to a second transceiver 276 at the base station 270. The base station controller 274, for example, may calculate drivable path plans and/or output control signals to control the curvature control system 232, the speed control system 240, and/or the implement control system 250 to direct the autonomous work vehicle toward the desired path, for example. The base station controller 274 may include a processor and memory device having similar features and/or capabilities as the processor and the memory device discussed previously. Likewise, the base station 270 may include an operator interface 272 having a display, which may have similar features and/or capabilities as the operator interface 222 and the display discussed previously.

In some embodiments, one or both of the base station 270 and/or the autonomous work vehicle may be in communication with a user device 280. A user device 280 may include a phone, tablet, laptop, or computer. The user device 280 may similarly include an operator interface 282 which may include similar features and capabilities as operator interfaces 222, 272 described above. Additionally, or alternatively, the user device 280 may comprise a controller 284 that may include the same or similar features, components, and/or characteristics as the controller 274 of the base station 270. For example, the user device 280 may calculate drivable path plans, output control signals to control the curvature control system 232, the speed control system 240, and/or the implement control system 250 to direct the autonomous work vehicle. The user device 280, for example, can include an application that allows the user (e.g., a remote operator) to communicate commands to the autonomous work vehicle (e.g., via a transceiver 286) and/or receive information about the autonomous work vehicle. Alternatively, or additionally, the user device 280, for example, can include an application that allows the operator to observe the autonomous work vehicle move through a map of the work area where the autonomous work vehicle operates.

The user device 280, for example, may include an application that can receive an indication associated with the remote operator or which can receive other user or operator inputs. The user device 280, for example, may include an application that can display any of the information disclosed in this document.

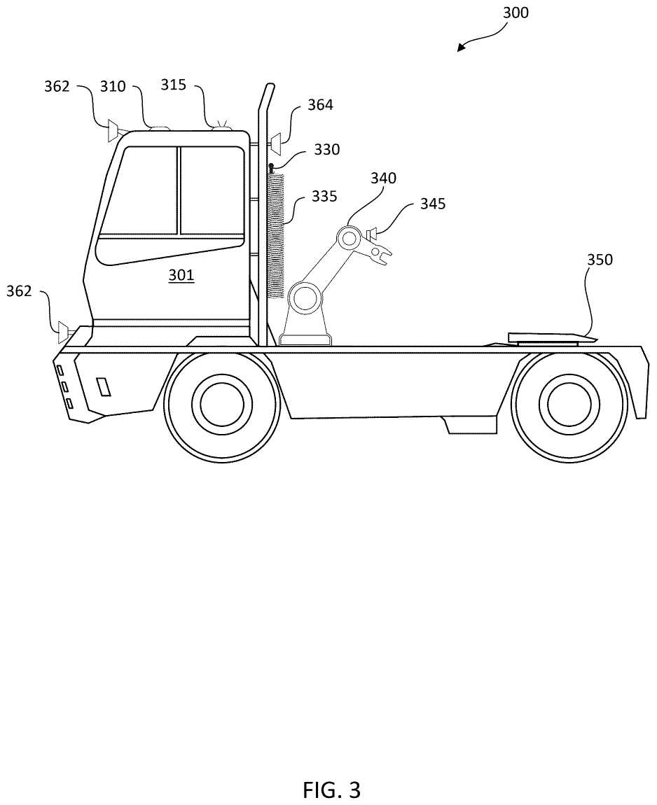

FIG. 3 is a side view of an autonomous yard truck 300 according to some embodiments. The autonomous yard truck 300 includes a cab 301 that may be used to drive the autonomous yard truck 300 manually. The autonomous yard truck 300 may include one or more of the components shown in FIG. 2. The autonomous yard truck 300 may also include a brake system, an engine, a transmission, steering, sensor array, etc. such as, for example, as shown in FIG. 2.

In some embodiments, the autonomous yard truck 300 may include a sensor array that includes sensors 362 (e.g., sensor array 160) disposed at various locations on the autonomous yard truck 300 such as, for example, on the cab 301, bumper, housing, frame, etc. The sensors 362 may include infrared sensors, ultrasonic sensors, magnetic sensors, radar sensors, LiDAR sensors, terahertz sensors, sonar sensors, cameras, etc. The sensor array of the autonomous yard truck 300 may also include one or more backup sensors 364 such as, for example, infrared sensors, ultrasonic sensors, magnetic sensors, radar sensors, LiDAR sensors, terahertz sensors, sonar sensors, cameras, etc.

In some embodiments, the autonomous yard truck 300 may include a spatial locating device (or GPS) antenna 310. In some embodiments, the autonomous yard truck 300 may include a transceiver antenna 315.

In some embodiments, the autonomous yard truck 300 may include one or more hoses 335 that can connect with a trailer such as, for example, two or three hoses. Each hose may have a hose connector 330 that can connect with a trailer hose connector. For example, the one or more hoses 335 of the autonomous yard truck 300 may include a service brake hose, an emergency brake hose, and/or a refrigerant hose.

In some embodiments, the autonomous yard truck 300 may include a robotic arm 340 disposed on the back bed of the autonomous yard truck 300. The robotic arm 340 may include any type of robotic arm. The robotic arm 340, for example, may exert high torque or high pressure sufficient to connect the hose connector 330 with the trailer hose connector. The hose connector 330 and/or the trailer hose connector may comprise a glad-hand connector. In some embodiments, when the autonomous yard truck 300 is not coupled with a trailer, the hose connector 330 may be positioned in a storage rack at some point on the autonomous yard truck 300 such as, for example, on the rear of the cab 301.

In some embodiments, the robotic arm 340 may include one or more arm sensors 345 such as, for example, infrared sensors, ultrasonic sensors, magnetic sensors, radar sensors, LiDAR sensors, terahertz sensors, sonar sensors, cameras, etc. The arm sensor 345, for example, may produce data that can be used to identify the location of a hose connector 330 and/or a trailer hose connector. The arm sensor 345, for example, may produce data that can show that a hose connector 330 and/or a trailer hose connector are sufficiently coupled.

In some embodiments, the autonomous yard truck 300 may include a fifth-wheel coupling 350. The fifth-wheel coupling 350, for example, may be raised or lowered with a fifth-wheel coupling boom. FIG. 3 shows the fifth-wheel coupling 350 in a lowered position. The fifth-wheel coupling 350 may couple with a kingpin of a trailer.

When the fifth-wheel coupling 350 is coupled with a kingpin and the fifth-wheel coupling 350 is in the raised position, the legs of the trailer may lift off the ground (e.g., automatically). This may allow the autonomous yard truck 300 to pull the trailer without individually raising the trailer legs.

In some embodiments, the robotic arm 340 and/or the arm sensor 345 may be coupled with a thermal management system. A thermal management system may, for example, be coupled with a thermal management system associated with the autonomous yard truck 300 such as, for example, coupled with the cab heating/cooling system and/or the engine heating/cooling system. A thermal management system may, for example, be an independent system that heats and/or cools the robotic arm 340 and/or the arm sensor 345. A thermal management system may, for example, keep the temperature of the robotic arm 340 and/or the arm sensor 345 between about 32° F. and about 100° F.

In some embodiments, the autonomous yard truck 300 may include a deployable shade coupled with the back of the cab 301. The deployable shade, for example, may be used to screen the sun and/or other lighting from the arm sensor 345 and/or the one or more backup sensors 364. The deployable shade, for example, may include an umbrella configuration or an awning configuration. The deployable shade, for example, may be coupled with the roof or an upper portion of the cab.

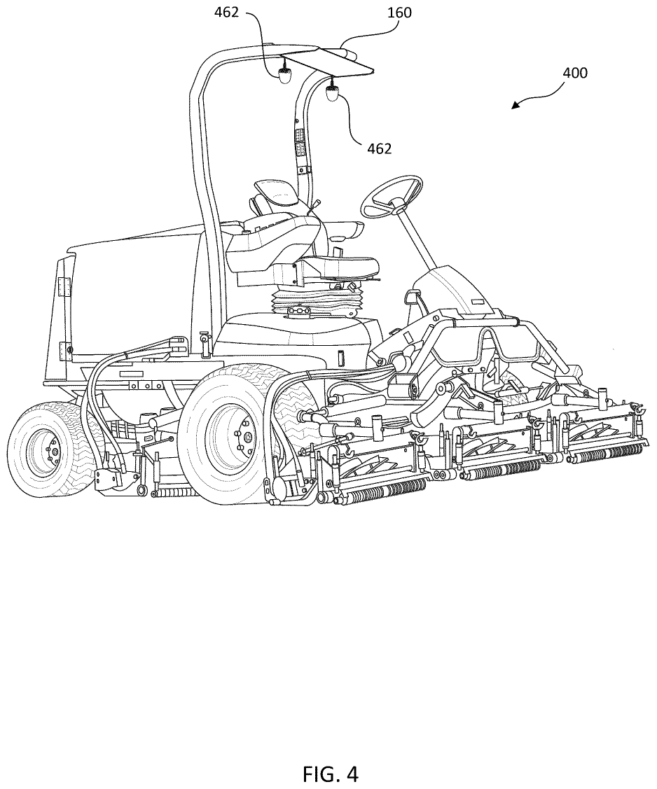

FIG. 4 is a sideview of an example autonomous mower 400, which may include all or some of the components of autonomous work vehicle. The autonomous work vehicle in this document may include the autonomous mower 400. Any type of mower or blades may be used, such as a disc mower. The autonomous mower 400, for example, may include a sensor array 160 (or multiple sensor arrays 160), including sensors 462. The sensor array 160 may include, for example, one or more LiDAR, radar, and/or video cameras. The video cameras, for example, may include 360 degree cameras, a front facing camera, and/or a back facing camera.

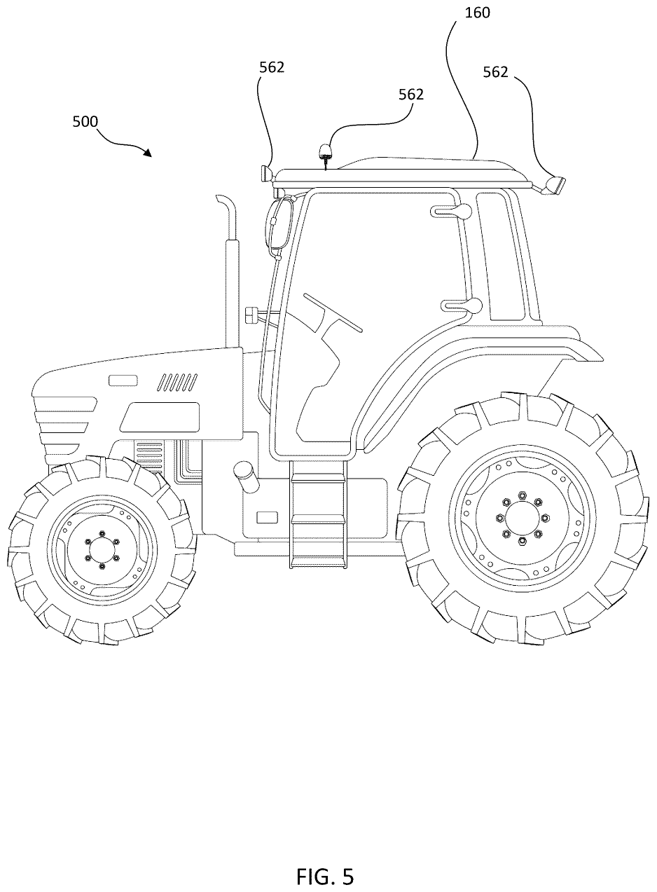

FIG. 5 is a sideview of an example autonomous tractor 500, which may include all or some of the components of autonomous work vehicle. The autonomous work vehicle in this document may include the autonomous tractor 500. In this example, the autonomous tractor 500 may include standard tractor equipment and/or components. The autonomous tractor 500 may include or be coupled with any kind of implement such as, for example, a plow, disc plow, reel mower, dumper, lift, bucket, shovel, blade, and/or cutter, etc. The autonomous tractor 500, for example, may include a sensor array 160 (or multiple sensor arrays 160), including sensor(s) 562. The sensor array 160 may include, for example, one or more LiDAR, radar, and/or video cameras. The video cameras, for example, may include 360 degree cameras, a front facing camera, and/or a back facing camera.

The computational system 600, shown in FIG. 6, can be used to perform any of the embodiments of the invention. For example, computational system 600 can be used to execute processes 700 and/or 800. As another example, computational system 600 can be used to perform any calculation, identification, and/or determination described here. Computational system 600 includes hardware elements that can be electrically coupled via a bus 605 (or may otherwise be in communication, as appropriate). The hardware elements can include one or more processors 610, including without limitation one or more general-purpose processors and/or one or more special-purpose processors (such as digital signal processing chips, graphics acceleration chips, and/or the like); one or more input devices 615, which can include without limitation a mouse, a keyboard, and/or the like; and one or more output devices 620, which can include without limitation a display device, a printer, and/or the like.

The computational system 600 may further include (and/or be in communication with) one or more storage devices 625, which can include, without limitation, local and/or network accessible storage and/or can include, without limitation, a disk drive, a drive array, an optical storage device, a solid-state storage device, such as a random access memory (“RAM”) and/or a read-only memory (“ROM”), which can be programmable, flash-updateable, and/or the like. The computational system 600 might also include a communications subsystem 630, which can include without limitation a modem, a network card (wireless or wired), an infrared communication device, a wireless communication device and/or chipset (such as a Bluetooth device, an 802.6 device, a Wi-Fi device, a WiMax device, cellular communication facilities, etc.), and/or the like. The communications subsystem 630 may permit data to be exchanged with a network (such as the network described below, to name one example), and/or any other devices described herein. In many embodiments, the computational system 600 will further include a working memory 635, which can include a RAM or ROM device, as described above.

The computational system 600 also can include software elements, shown as being currently located within the working memory 635, including an operating system 640 and/or other code, such as one or more application programs 645, which may include computer programs of the invention, and/or may be designed to implement methods of the invention and/or configure systems of the invention, as described herein. For example, one or more procedures described with respect to the method(s) discussed above might be implemented as code and/or instructions executable by a computer (and/or a processor within a computer). A set of these instructions and/or codes might be stored on a (e.g., non-transitory) computer-readable storage medium, such as the storage device(s) 625 described above.

In some cases, the storage medium might be incorporated within the computational system 600 or in communication with the computational system 600. In other embodiments, the storage medium might be separate from a computational system 600 (e.g., a removable medium, such as a compact disc, etc.), and/or provided in an installation package, such that the storage medium can be used to program a general-purpose computer with the instructions/code stored thereon. These instructions might take the form of executable code, which is executable by the computational system 600 and/or might take the form of source and/or installable code, which, upon compilation and/or installation on the computational system 600 (e.g., using any of a variety of generally available compilers, installation programs, compression/decompression utilities, etc.) then takes the form of executable code.

The computational system 600 may be configured to operate an autonomous work vehicle platform. The term “autonomous work vehicle”, and related terms (e.g., “autonomous work vehicle platform”), as used herein may include manned vehicles, remote control vehicles, and/or manual vehicles, etc. The autonomous work vehicle platform may comprise a steering mechanism in communication with the processor, where the processor communicates steering commands to the steering mechanism based on the temperature of the implement. The autonomous work vehicle platform may comprise a braking mechanism in communication with the processor, where the processor communicates braking commands to the braking mechanism based on the temperature of the implement. The autonomous work vehicle platform or adjustable implement system may comprise an implement control system in communication with the processor, where the processor communicates commands to the implement control system based on the position of the implement. For example, the processor may give commands to the implement control system for controlling a pump to induce a flow of hydraulic fluid (e.g., at a predetermined flow rate) into or out of the hydraulic cylinder for a set time.

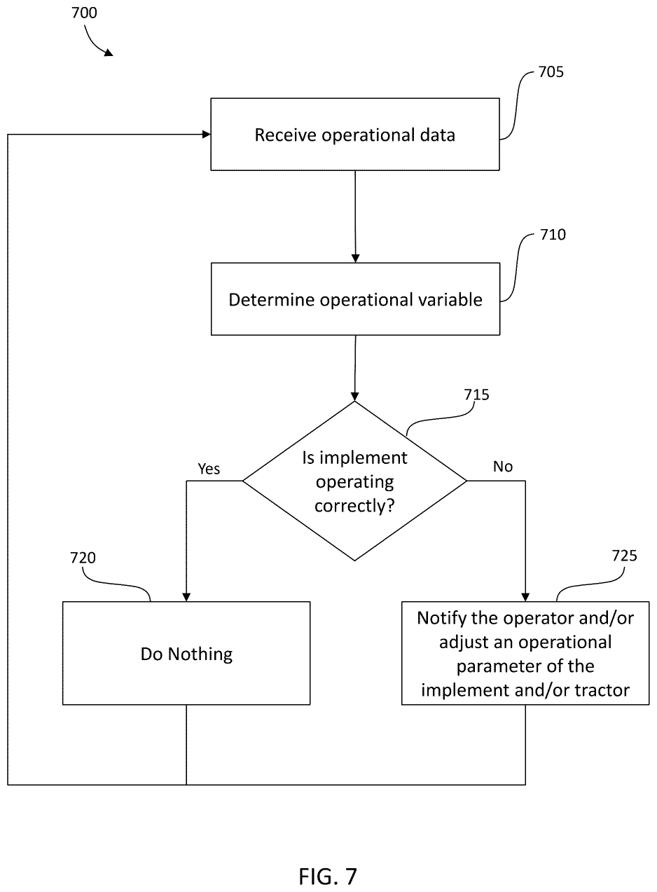

FIG. 7 is a flow chart of a method or process 700 for correcting operation of an implement, such as the implement 114 in FIG. 1. Process 700 may be executed in part by control system systems of the autonomous work vehicle (including the vehicle control unit 220 and/or implement control system 250) and/or base station controller 274.

Process 700 starts at block 705. At block 705, a correction subsystem may receive operational data. The correction subsystem may be a subsystem of the autonomous work vehicle and which may be configured to determine a change or correction of operational parameters for execution by the autonomous vehicle system 100. The correction subsystem (e.g., instructions and/or software of the correction subsystem) may be executed by the one or more processors 610 described above. In some examples, the correction subsystem may be an implement correction subsystem, or may be a tractor correction subsystem such that the position or operation of the implement and/or tractor 112 may be adjusted based on the operational data. Operational data may be received from the sensor array 160. Operational data may comprise implement data (i.e., data indicating the performance, position, temperature, or other parameter of the implement) and/or environmental data (i.e., data indicating the position of objects within the operating environment of the autonomous work vehicle). For example, environmental data may comprise the portion of the operational data that does not indicate a position or other parameter of the autonomous work vehicle and implement 114.

Operational data may comprise implement data indicating a parameter (e.g., temperature) of the implement or of a component of the implement. Operational data may include one or more of temperature of, and/or around, an implement (or implement component), or a temperature profile around an implement (or implement component), or rate of change of temperature of the implement (or implement component). For example, the operational data may include the temperature of an implement component comprising a disc 120 of a disc harrow implement. The operational data may be sent from a sensor of the sensor array 160. The sensor may be a visual sensor, such as a LiDAR sensor, a camera (e.g., a stereo camera), a radar, or other visual sensor configured to send data (i.e., operational data) that may be used to represent the operating environment in a virtual space. The sensor may additionally, or alternatively, be configured to provide temperature data. For example, the sensor may comprise an infrared camera, a thermal imager, a LiDAR sensor, a pyrometer, or other sensor configured to send temperature data.

The visual sensor may be used to send operational data that indicates both temperature and data used to navigate the autonomous work vehicle. For example, the visual sensor may comprise an infrared sensor that may send operational data the indicates the temperature of the implement (i.e., implement data) and that indicates the position of objects within the operating environment lying away from the autonomous work vehicle and/or which includes data points representing the operating environment and which may be used to generate a path through the operating environment.

Operational data may include shapes, colors, and/or relative positions on or around an implement from light data from, for example a camera, or distance data from, for example, a lidar or radar sensor. This could show the coverage of seeding or fertilizing, such as in hydroseeding, or clumps of soil forming on a disc 120 with a disc harrow, for example.

At block 710, the correction subsystem may determine the operational variable. For example, the correction subsystem may determine the temperature of the implement and/or the implement component based on the operational data.

At block 715, the correction subsystem may determine whether the implement is operating correctly. The determination may be based on the operational data received from the sensor array 160. Determining whether the implement is operating correctly may include comparing the operational data to a respective operating envelope or threshold to determine whether the operational data is within the operating envelope, or below or above a threshold. It may include monitoring just one operational variable, or multiple operational variables, and correlating the one or multiple operational variables (e.g., over time) for more accurate determinations. The operational envelope may be a constant set of values for a particular type of operational data, or may be a dynamic range of acceptable values which changes depending on conditions.

If the correction subsystem determines that the implement is operating correctly, for example, if the operational variable is determined to be within the operational envelope, the process 700 may proceed to block 715, in which no changes are made, and from there the method may return to block 705.

If the correction subsystem determines that the implement is not operating correctly, for example, if the operational variable is determined to be outside the operational envelope, the process 700 may proceed to block 720, in which an operational parameter of the implement and/or tractor is adjusted to ensure that the implement is operating correctly and/or in which the user is notified, for example by an error message which may be sent to a user. From there, the process 700 may return to block 705.

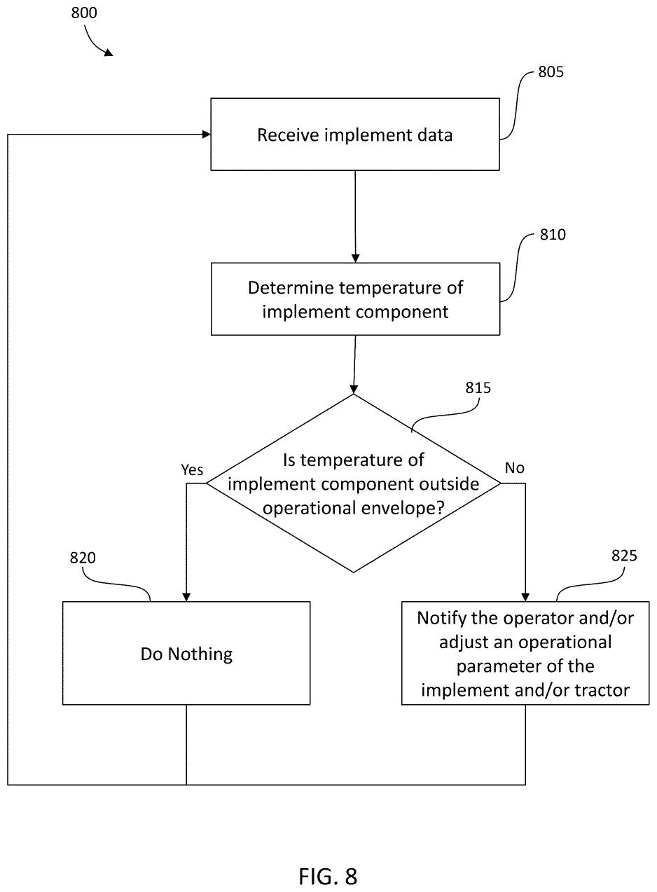

FIG. 8 illustrates a method or process 800 which is a variation of process 700 disclosed above. Specifically, process 800 may illustrate the process 700 with respect to temperature detection of the implement and/or implement component. Thus, block 805 may correspond to block 705, block 810 may correspond to block 710, block 815 may correspond to block 715, block 820 may correspond to block 720, and block 825 may correspond to block 725.

At block 805, the correction subsystem may receive operational data comprising implement data from the sensor array 160. The implement data may comprise temperature data of the implement or one or more components of the implement. For example, as in the example of FIG. 1, the implement 114 may comprise a disc harrow.

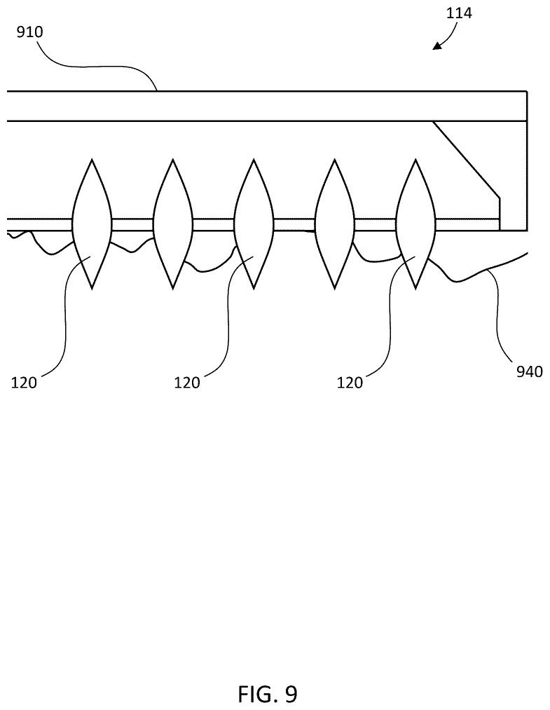

FIG. 9 illustrates a close view of an articulating beam 910 and the discs 120 of the disc harrow of FIG. 1 as they penetrate the substrate 940. If the penetration depth of the discs 120 is too high (i.e., the discs 120 are too deep in the soil or substrate 940), then clumps of soil may pile up around the discs 120. Due to the spinning bearings generating heat, under correct operating conditions, the discs 120 show up as a plurality of discrete hotspots on an infrared camera. However, clumps of soil forming around any bearing may cool the respective bearing or obscure the heat of the respective bearing hotspot from the infrared camera, such that the temperature at the discrete hotspot may appear to be lower than the other bearing hotspots (e.g., may be below a first constant or static threshold, or below a dynamic threshold which is related to the temperature of all of the bearing hotspots).

In some examples, implement health may be determined, such as, if a single bearing is not spinning at all due to a problem with the disc 120 or bearing, it will not heat up or will lose heat, and so the temperature at the expected bearing hotspot may be below a second threshold which may also be a static threshold, or a dynamic threshold based on the temperature of other bearing hotspots. In further examples, if the bearings on one or more of the discs 120 are damaged, the disc 120 may be spinning but the bearings may be generating more heat than the other bearings, and so the temperature at the expected bearing hotspot may be above a third threshold which may also be a static threshold, or a dynamic threshold based on the temperature of other bearing hotspots.

The second and third thresholds may be higher or lower than the first threshold depending on the conditions of the soil and the air temperature. For example, a clump of soil obscuring the bearing (e.g., from the visual sensor field of view) may show a different temperature to a bearing which is not spinning at all, as a top layer of soil usually has a different temperature than the surrounding air. In some examples, where the penetration depth of the discs 120 is too low (i.e., the discs 120 are not penetrating deep enough into the soil, or not penetrating into the soil at all), none of the discs 120 may be spinning, or they may not be spinning enough, such that all or multiple of the bearings may not heat up, or gradually lose heat (e.g., at a rate higher than those discs 120 spinning at a higher rate). The rate of change (e.g., loss) of temperature at all or multiple of the bearing hotspots may therefore be above a threshold rate.

In further examples, if the penetration of the discs 120 is too high, the clumps of soil may be detected by a lidar or radar sensor or a standard camera which may sense or determine that a volume around the discs 120 has grown in size compared to the other discs 120 or compared to a history of volume sizes around that disc 120, or alternatively compared to a static threshold. In yet further examples, where the implement is, for example, a chisel or cultivator, the sensor, such as a camera, lidar or infrared camera, may determine whether the soil is being turned over properly, for example, by monitoring the temperature profile of the substrate (e.g., soil) behind the implement as the layer of substrate just under the top will be a different temperature than the top surface of the substrate.

At block 810, the process 800 may include determining a temperature of the implement 114 or implement component (e.g., the discs 120) based on the implement data. This may include the detection of the component, for example, based on the shape of the component. For example, detection software or a machine learning algorithm may be configured or trained to detect the implement 114 or the implement component. In some embodiments, detection of the implement 114 and/or the implement component may be based on a known or expected location of the implement 114 or implement component.

At block 815, the method may include determining if the implement 114 is operating correctly, specifically that temperature of the implement 114 and/or implement component are within the operational envelope. If the implement 114 is operating correctly, the method may return to block 805 to continue the operational task of the autonomous vehicle system 100.

If the implement is not operating correctly, if the temperature of the implement 114 and/or implement component do not lie within the operational envelope (e.g., are above or below an operational threshold), the autonomous work vehicle or autonomous vehicle system 100 may proceed to block 825.

At block 825, the autonomous work vehicle or autonomous vehicle system 100 may perform an operational adjustment. The operational adjustment may be configured to return the implement 114 and/or implement component to a temperature within the operating envelope. This may improve operational efficiency or accuracy or may prevent and/or reduce damage to one or more components of the implement 114. The operational adjustment may comprise adjustment to an operational parameter of the autonomous work system, including an adjustment to the autonomous work vehicle or to the implement. For example, the operational adjustment may include adjusting a height of the implement 114 or may include adjusting a velocity of the autonomous work vehicle. Block 825 may further comprise calculating a desired value of an operational parameter, and instructing one or more control systems (e.g., the implement control system 250, the steering control system 230, and/or the speed control system 240) to adjust the operational parameter to the desired value.

In the examples of FIG. 1 and FIG. 9, where the implement 114 is a disc harrow, the operational parameter which is adjusted may be the penetration depth of the discs 120 or the height of the implement 114, which can be adjusted to a desired value (i.e., a desired position or height) by extending or retracting the hydraulic cylinder 122. In some embodiments, the height of implement 114 may be adjusted such that one or more of the discs 120 are extracted from the substrate 940. In some examples, adjusting the operational parameter may simply comprise moving the implement 114 to a different position. In further examples, the operational parameter may be any suitable controllable parameter of operation of the implement, such as position, speed of movement, pressure, and/or angle.

The comparison of the implement component temperature to the operational envelope may comprise comparing a first temperature of a first component of the implement 114 to a second temperature to a second component of the implement 114. The operational adjustment may be performed when the difference between the first and second temperatures exceeds a difference threshold of the operational envelope. The desired value of an operational parameter may then be calculated, which may be configured to reduce the temperature difference between the first and second temperatures of the first and second components of the implement 114. The operational adjustment may then be performed to adjust the operational parameter to the desired value. In some embodiments, the operational adjustment may be performed when the difference between the first and second temperatures is below a difference threshold of the operational envelope and the desired value may be configured to raise the temperature difference above the difference threshold.

In some embodiments, the operational adjustment may comprise a change in an operational parameter of the autonomous work vehicle. For example, when a temperature of the implement component is detected as lying outside the operational envelope, the correction subsystem may calculate a desired value comprising a desired velocity of the autonomous work vehicle. The desired velocity may be configured to return the temperature of the implement component to a value within the operational envelope and/or to reduce or prevent harm to the implement 114. The correction subsystem may then instruct the speed control system 240 to adjust the velocity of the autonomous work vehicle to the desired velocity.

In another example, when a temperature of the implement component is detected as lying outside the operational envelope, the correction subsystem may calculate a desired value comprising a deviation from a selected path or a new path. The correction subsystem may then instruct the steering control system 230 to follow the deviation from the selected path or the new path. The deviation from the selected path or new path may be configured to return the temperature of the implement component to a value within the operational envelope and/or to reduce or prevent harm to the implement 114. For example, the deviation from the selected path or the new path may direct the autonomous work vehicle over a substrate 940 having a more even surface, or comprising a different substrate 940, or to an area within the operating environment to protect the implement 114.

Finally, the operational adjustment may comprise sending a notification to an operator (e.g., a remote operator) of an abnormal temperature (i.e., a temperature outside the operational envelope) at the implement 114. The notification may comprise information as to which component of the implement exhibited a temperature outside the operational envelope and/or the conditions and/or operational parameters of the autonomous vehicle system 100 when the abnormal temperature of the implement 114 and/or implement component was detected.

Numerous specific details are set forth herein to provide a thorough understanding of the claimed subject matter. However, those skilled in the art will understand that the claimed subject matter may be practiced without these specific details. In other instances, methods, apparatuses or systems that would be known by one of ordinary skill have not been described in detail so as not to obscure claimed subject matter.

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The terms “autonomous vehicle” and/or “autonomous work vehicle” may include manned vehicles, remote control vehicles, manual vehicles, etc.

Unless otherwise specified, the term “substantially” means within 5% or 10% of the value referred to or within manufacturing tolerances. Unless otherwise specified, the term “about” means within 5% or 10% of the value referred to or within manufacturing tolerances.

The terms “first”, “second”, “third”, etc. are used to distinguish respective elements and are not used to denote a particular order of those elements unless otherwise specified or order is explicitly described or required.

The conjunction “or” is inclusive.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

That which is claimed:

1. An autonomous work vehicle comprising:
a steering control system for autonomously controlling a driving direction of the autonomous work vehicle;
a speed control system for autonomously controlling a speed of the autonomous work vehicle;
an implement connection between the autonomous work vehicle and an implement, wherein the implement is configured to interface with objects of an operating environment;
an implement control system for autonomously controlling a position of the implement;
a sensor array comprising one or more sensors configured to measure temperature of one or more implement components of the implement;
one or more processors communicatively coupled with the sensor array, the steering control system, the speed control system, and the implement control system; and
one or more computer-readable media having stored thereon instructions that when executed cause the one or more processors to:
receive implement data from the sensor array, wherein the implement data indicates a temperature of one or more implement components;
determine a first temperature of a first component of the one or more implement components;
compare the first temperature to an associated operational envelope of the implement; and
when the first temperature of the first component is outside the operational envelope:
calculate a desired value of an operational parameter of the autonomous work vehicle or implement, wherein the desired value of the operational parameter is configured to return the first component to a second temperature lying within the operational envelope; and
perform an operational adjustment by instructing the implement control system, the steering control system, and/or the speed control system to adjust the operational parameter of the autonomous work vehicle or implement to the desired value.

2. The autonomous work vehicle of claim 1, wherein the instruction further cause the one or more processors to:
determine a third temperature of a second component of the one or more implement components;
compare the third temperature to the operational envelope; and
when the first temperature and the third temperature lie outside the operational envelope:
calculate the desired value of the operational parameter of the autonomous work vehicle or implement, wherein the desired value of the operational parameter of the autonomous work vehicle or implement is configured to return the first component to a second temperature lying within the operational envelope and to return the second component to a fourth temperature lying within the operational envelope; and
instruct the implement control system, the steering control system, and/or the speed control system to adjust the operational parameter of the autonomous work vehicle or implement to the desired value.

3. The autonomous work vehicle of claim 2, wherein comparing the first temperature and the third temperature to the operational envelope comprises determining a temperature difference between the first temperature and the third temperature, and wherein the first temperature and third temperature lie outside the operational envelope when the temperature difference between the first temperature and the third temperature exceeds a difference threshold of the operational envelope.

4. The autonomous work vehicle of claim 1, wherein the operational parameter comprises a position of the first component of the one or more components of the implement, wherein the desired value comprises a desired position of the first component, and wherein performing the operational adjustment comprises instructing the implement control system to adjust a position of the first component to the desired position.

5. The autonomous work vehicle of claim 1, wherein the operational parameter comprises a velocity of the autonomous work vehicle, wherein the desired value comprises a desired velocity of the autonomous work vehicle, and wherein performing the operational adjustment comprises instructing the speed control system to adjust a velocity of the autonomous work vehicle to the desired velocity.

6. The autonomous work vehicle of claim 1, wherein the operational parameter comprises a selected path of the autonomous work vehicle, wherein the desired value comprises a deviation from the selected path, and wherein performing the operational adjustment comprises instructing the steering control system to follow the deviation from the selected path.

7. The autonomous work vehicle of claim 1, wherein the instructions further cause the one or more processors to, when the first temperature of the first component is outside the operational envelope, send an abnormal temperature notification to an operator.

8. The autonomous work vehicle of claim 1, wherein the one or more sensors of the sensor array comprise an infrared sensor, a thermal imager, a pyrometer, or a LiDAR sensor.

9. The autonomous work vehicle of claim 1, wherein:
a first sensor of the sensor array generates operational data, wherein the operational data includes the implement data used to determine the first temperature of the first component and environmental data that represents the operating environment of the autonomous work vehicle; and
wherein the instructions further cause the one or more processors to:
generate a path through an operating environment based on the environmental data; and
instruct the steering control system and the speed control system to drive the autonomous work vehicle along the path.

10. The autonomous work vehicle of claim 1, wherein the instructions further cause the one or more processors to receive environmental data from the sensor array, wherein the environmental data indicates a temperature profile of a substrate of the operating environment lying behind the implement.

11. The autonomous work vehicle of claim 1, wherein the operational parameter comprises engine torque, fuel burn rate, traction, wheel slip, engine rpm, steering effectiveness, and/or a velocity of the autonomous work vehicle.

12. The autonomous work vehicle of claim 1, wherein the implement comprises a tillage implement or seeder comprising a ground engaging tool configured to penetrate a substrate.

13. The autonomous work vehicle of claim 12, wherein the operating parameter comprises an operating depth of the ground engaging tool, and wherein the instructions further cause the one or more processors to determine, based on the operational parameter, whether the ground engaging tool is operating at a correct depth in the substrate based on comparison of the first temperature to the associated operational envelope.

14. A method for adjusting a position of an implement, the method comprising:
receiving implement data from a sensor array, wherein the implement data indicates a temperature of one or more implement components of an implement;
determining a first temperature of a first component of the one or more implement components;
comparing the first temperature to an associated operational envelope of the first component; and
when the first temperature of the first component is outside the operational envelope:
calculating a desired value of an operational parameter of an autonomous work vehicle or implement, wherein the desired value of the operational parameter is configured to return the first component to a second temperature lying within the operational envelope; and
performing an operational adjustment by instructing an implement control system, a steering control system, and/or a speed control system to adjust an operational parameter of the autonomous work vehicle or implement to the desired value.

15. The method of claim 14, wherein the operational parameter comprises a position of the first component of the one or more components of the implement, wherein the desired value comprises a desired position of the first component, and wherein performing the operational adjustment comprises instructing the implement control system to adjust a position of the first component to the desired position.

16. The method of claim 14, further comprising:
receiving operational data from a first sensor of the sensor array, wherein the operational data includes the implement data used to determine the first temperature of the first component and environmental data that represents an operating environment of the autonomous work vehicle; and
generating a path through an operating environment based on the environmental data; and
instructing a steering control system and a speed control system to drive the autonomous work vehicle along the path.

17. The method of claim 14, further comprising, when the first temperature of the first component is outside an operational envelope, sending an abnormal temperature notification to an operator.

18. A non-transitory computer-readable storage medium comprising instructions for executing the method according to claim 14.

19. An autonomous work vehicle comprising:
a steering control system for autonomously controlling a driving direction of the autonomous work vehicle;
a speed control system for autonomously controlling a speed of the autonomous work vehicle;
an implement connection between the autonomous work vehicle and an implement, wherein the implement is configured to interface with objects of an operating environment;
an implement control system for autonomously controlling a position of the implement;
a sensor array comprising one or more sensors configured to measure temperature of one or more implement components of the implement;
one or more processors communicatively coupled with the sensor array, the steering control system, the speed control system, and the implement control system; and
one or more computer-readable media having stored thereon instructions that when executed cause the one or more processors to:
receive implement data from the sensor array, wherein the implement data indicates a temperature of one or more implement components;
determine a first temperature of a first component of the one or more implement components;
compare the first temperature to an associated operational envelope of the first implement; and
when the first temperature of the first component is outside the operational envelope, send an abnormal temperature notification to an operator.

20. The autonomous work vehicle of claim 19, wherein when the first temperature of the first component is outside an operational envelope, the instructions further cause the one or more processors to:
calculate a desired position of the implement, wherein the desired position of the implement is configured to return the first component to a second temperature lying within the operational envelope; and
instruct the implement control system to adjust the position of the implement to the desired position.
